(19) United States
(12) Patent Application Publication
(10) Pub. No.: US 2006/0205421 A1
(43) Pub. Date: Sep. 14, 2006

(54) Wireless communication devices and methods

(76) Inventor: Paul Record, Edinburgh (GB)

Correspondence Address: YOUNG & BASILE, P.C., 3001 WEST BIG BEAVER ROAD, SUITE 624, TROY, MI, 48084, US

(21) Appl. No.: 11/434,534

(22) Filed: May 15, 2006

(30) Foreign Application Priority Data
Nov. 11, 2004 (WO) PCT/GB04/04746
Nov. 14, 2003 (GB) 0326590.7

(51) Int. Cl. H04B 7/005

(52) U.S. Cl. 455/502

(57) ABSTRACT

A method for synchronising a transmitter and a mobile, wireless receiver, the method involving: transmitting from the transmitter a synchronisation message (5) that is indicative of a time until a command transmission (6); receiving the synchronisation message at the receiver, and using the received synchronisation message to determine when the next command transmission is to occur.

### RELATED APPLICATION

This application claims priority to PCT Application No. PCT/GB2004/004746 dated Nov. 11, 2004 and U.K. Patent Application No. 0326590.7 dated Nov. 14, 2003.

### FIELD OF THE INVENTION

The present invention relates to a method for improving communications between mobile devices.

### BACKGROUND

To allow communication between two or more remote devices, one device has to transmit and the recipient or recipients must respond. To conserve power the receiver at the recipient device is mostly off, as the power consumption in the receiver is directly proportional to the receiver on-time. In order for the receiver to respond to the transmitter without an undue delay it must periodically turn on in order to receive signals from the transmitter during any transmission interval. Generally, since the receiver does not know in advance when to turn on, it must turn on at least twice within that transmission interval to respond.

One method for addressing the problem of when to switch the receiver on is to use synchronised clocks carried in each of the transmitter and receiver devices. To do this, when first turned on the receiver in the transponder must carry out an exhaustive search to find the transmitter and synchronize its internal clock to that in the transmitter. It then turns itself off to conserve power, and at a later pre-determined point in time and according to its internal transmitter-synchronized clock, turns itself on again in order to receive the signal from the transmitter.

Synchronising internal receiver and transmitter clocks is suitable for frequently accessed devices such as mobile phones. However, if the remote device is accessed infrequently, say once a week or month such as in the case of animal or asset tracking, the time between synchronisation and transmission is sizeable. As a consequence, and due to drift between the two clocks, when the receiver turns on again to receive the transmission according to its synchronized internal clock, it can be required to remain on for a relatively long time before receiving said transmission. This consumes power. For example as illustrated in FIG. 1 if a base station 1 sends out a request 2 at lHz and a remote unit 3 sampling rate 4 has drifted to 1.05 Hz then the remote will only ‘see’ the base station every 20 seconds and therefore would take 20 times as long as it would if they were both synchronised. Clearly, this has an impact on power consumption.

One solution to deal with increased power demands is to use a larger battery. However, in many applications, minimising the total device size is a very important factor. In the case of wildlife tracking/monitoring mobile wireless devices, it is desirable that battery life is as long as possible, and at the same time the device is as small as possible. This is because changing the battery is practically difficult and often impossible and there is a physical limit as to the size of device an animal can carry without it causing a negative effect on the movement of that animal.

Another problem concerning wireless battery powered transponders is how to combine a long battery life with the long range identification of a transponder in an embedded environment. Currently this is not possible for a small device. Also, where there is a multitude of transponders in close proximity, it can be difficult to ensure the simultaneous and separate identification of these transponders over a long range. Currently ‘anti-collision’ techniques are used which require tags to respond in turn by turning others off. In practice, this means that the more tags there are in the field under examination the longer it takes to read them, as the tags have to be read sequentially.

Yet another problem occurs where there is a need to identify one target containing an embedded transponder from a multitude of like targets. This is because when radio frequency devices are placed in or in close proximity to materials, both conducting and insulating, their radio frequency performance changes. When deeply implanted in an animal body or attached to metal the signal path is altered and often severely attenuated. In the case of insulating materials, liquids or solids, the electromagnetic wave velocity is slowed down inversely in proportion to the square root of the dielectric constant. In the case of conducting objects the signal is attenuated. Thus the radiating antenna needs to be modified in structure. Also, signal encoding techniques that can survive large signal attenuations have to be used. A partial solution to this problem can be found in King R. W. P., S. G. S., Owens M, Tai Tsun Wu (1981), “Antennas in matter fundamentals, theory and applications, chapter 12 Construction of Experiment models”, MIT press. Nevertheless, there remains a need for an improved device and/or method that addresses at least one of the problems described above.

### SUMMARY OF INVENTION

According to one aspect of the present invention there is provided a method for synchronising a transmitter and a receiver, the method involving transmitting from the transmitter a synchronisation message that is indicative of a time until a command transmission; receiving the synchronisation message at the receiver, and using the received synchronisation message to determine when the next command transmission is to occur.

By using a synchronisation message that is indicative of a time until a command transmission, there is provided a means for effectively and accurately synchronising communication whilst minimising power consumption and device component size.

Preferably, the synchronisation message is a synchronisation pulse sequence having a plurality of pulses, each pulse in the sequence being indicative of a time until a command transmission, and the receiver is operable to receive at least one of the pulses, and use it to determine when the next command transmission is to occur.

Preferably, each synchronisation pulse has a width that can be used by the receiver device to work out and identify when a command transmission will be sent to that receiver device. More specifically the pulse width may be directly proportional to the time until the next command transmission.

The synchronisation message may include overlapping m-sequence codes, wherein the separation between auto-correlations peaks of these codes is indicative of the time until the command transmission.

The synchronisation message may include a plurality of pulses, and the average width of the pulses may be indicative of the time until the command transmission.

The synchronisation message may include a plurality of pulses, and the average interval between adjacent pulses may be indicative of the time until the command transmission.

According to another aspect of the present invention there is provided a system having a transmitter and a mobile, wireless receiver, the transmitter being operable to transmit a synchronisation message indicative of a time until a command transmission, and the receiver being operable to receive that synchronisation message, and use it to determine when the next command transmission is to occur.

According to another aspect of the present invention there is provided a method for synchronising a mobile, wireless receiver with a remote transmitter, the method involving: receiving from the transmitter at least one synchronisation message indicative of a time until a command transmission, and using it to determine when the next command transmission is to occur.

According to still another aspect of the present invention there is provided a mobile device having a receiver, the device being operable to receive from a transmitter a synchronisation message that is indicative of a time until a command transmission, and use the synchronisation message to determine when the next command transmission is to occur.

According to another aspect of the present invention there is provided a method for synchronising a mobile, wireless receiver with a remote transmitter, the method involving transmitting from the transmitter a synchronisation message that is indicative of a time until a command transmission.

According to a still further aspect of the present invention there is provided a transmitter that is operable to communicate with a mobile, wireless receiver the transmitter being operable to transmit a synchronisation message that is indicative of a time until a command transmission.

According to still another aspect of the invention, there is provided a mobile device that includes a transmitter that is operable to transmit a synchronisation message that is indicative of a time until a command transmission, and a receiver that is operable to receive a synchronisation message that is indicative of a time until a command transmission from another device, and use it to determine when the next command transmission is to occur.

### BRIEF DESCRIPTION OF THE DRAWINGS

Various aspects of the present invention will now be described by way of example only and with reference to the accompanying drawings, of which:

FIG. 2 is a schematic view of a transmission pulse sequence;

FIG. 3 is a block diagram of a linear shift register;

FIG. 4 is an illustration of a m-sequence autocorrelation function for a m-sequence code;

FIG. 5 is a schematic view of a transmission pulse sequence that includes a m-sequence code;

FIG. 6 is an illustration of a m-sequence autocorrelation function for the sequence of FIG. 5;

FIG. 7 is a schematic view of yet another transmission pulse sequence;

FIG. 8 is a schematic view of still another transmission pulse sequence, and

FIG. 9 is a block diagram of a receiver.

### DETAILED DESCRIPTION OF THE DRAWINGS

To synchronise a transmitter and a mobile receiver, the method in which the invention is embodied uses one or more pulses that are indicative of a time until a command transmission. Hence, in contrast to prior art arrangements the invention uses a time differential measure for synchronisation, rather than an indication of the absolute time of transmission. Transmitter and/or receiver devices may include hardware and/or software for implementing this methodology.

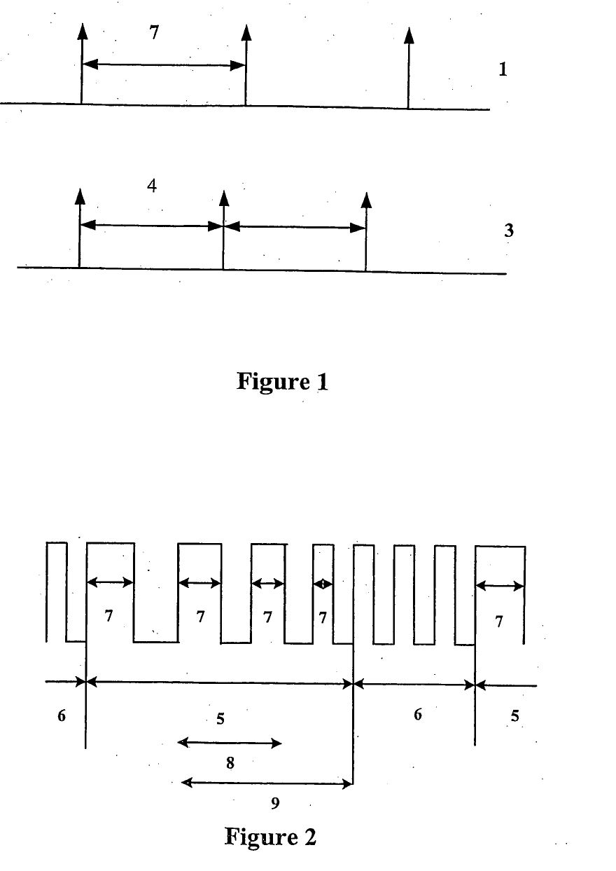

FIG. 2 shows two sets of pulses that are sent out sequentially from a transmitter, one set forming the content of a period known herein as the synchronisation period 5, and the second set forming the content of a period of time known herein as the command period 6. During the synchronisation period 5, the pulses transmitted are synchronisation pulses in the form of a time code. More specifically, the pulses have a separation time 7 (being the time between the rising or falling edges of each pulse) that decreases at a fixed rate that is known, and continues to do so over a period of time. The width of each synchronisation pulse is directly proportional to the time that will elapse until the next command period 6.

During the command period 6, the pulses made by the transmitter device contain information for or signifying instructions to the receiver device. After receiving these, the receiver device may perform a task. This task can include the sending of an identification signal or indeed any data or information from the receiver device, or any device attached thereto, to the transmitter device. This can be done using any method of communication. This task can include instructions as to the future behaviour of the receiver device or any device attached thereto, such as instructions commanding the receiver device, or any device attached thereto, to collect certain data.

The receiver is operable to determine from measuring the length of one or more synchronisation pulses the period of time that will elapse before the next command period 6 occurs. This is calculated as follows: t₉=A*t₇, where t₉ is the time 9 from the beginning of a transmission synchronisation interval 8 (i.e. the period over which the receiver receives one or more synchronisation pulses) until the beginning of the command period 6; t₇ is the length of any measured transmission synchronisation pulse 7 and A is a predetermined constant. Therefore, the receiver need only turn on for one transmission synchronisation interval period 8 to discover the time that will elapse, period 9, before the command period 6 will occur, and thus to synchronise itself to turn on for the command transmission 6. The measurement by the receiver of transmission synchronisation interval period 8, as previously mentioned, can be as short as the length in time of a single synchronisation pulse contained within the synchronisation period, i.e. period 7. Following synchronisation, the receiver can turn itself off until the time of the command transmission 6, when it switches itself back on. Any suitable means for measuring the elapsed time can be used, such as an internal clock or a counter mechanism, such as a count down timer.

Various device configurations can be used to implement the method of FIG. 2. In one example, the transmitting device contains a microprocessor or microcontroller capable of constructing the synchronization and the command period from pre-programmed synchronisation sequence information. The corresponding receiver unit has a similar processor or controller and software to sample and lock on to the synchronisation. Part of this is an exact copy of the sequence information contained within the transmitting device, so the units can become synchronised in time through the measurement of a single interval or synchronisation pulse.

Whilst in the example described with reference to FIG. 2, the time until the next command transmission is encoded within each pulse of a simple pulse sequence, other encoding schemes could be used. For example, in order to address only one receiver device amongst a plurality of receiver devices or to enable the reception of one signal from one particular receiver device when many receiver devices are transmitting, the synchronisation message may take the form of uniquely encoded signals, rather than the simple pulse sequence described with reference to FIG. 2. Any suitable orthogonal encoding scheme can be used, but in a preferred example, overlapping maximal length sequence codes, or m-sequence codes, (MSC) 14 are used.

M-sequence codes have the following properties: the sequences of ‘1’ and ‘0’ are roughly equal; only one correlation peak occurs when the code is shifted in time on itself by one complete non-repeating sequence and that different codes are orthogonal. One example is a linear feedback register with the equation:
Y=1+X³+X⁴

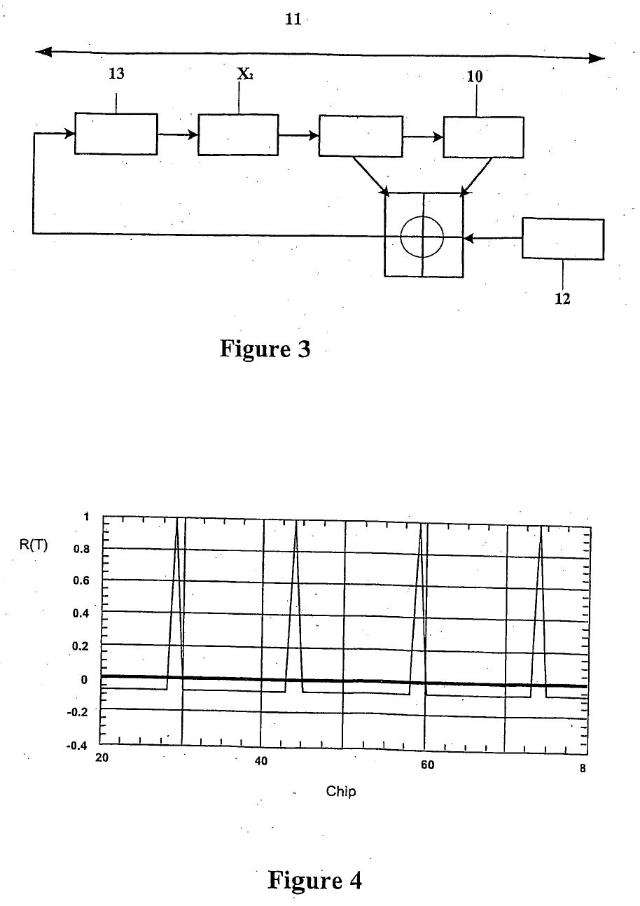

This maybe implemented as a shift register with feedback as illustrated in FIG. 3. In this, X₃(9) and X₄ (10) are the feedback points (stages 3 and 4) in a 4 stage shift register forming the returned ID (11). These are modulo 2 added to the input at the stage illustrated as (12). X₁ (13) is initially loaded with 1 and after 15 clocks the bit pattern at the output is thus 00010011010111. By increasing the number of stages then a longer bit pattern can be generated.

The normalised autocorrelation function of a periodic waveform x(t) can be stated as

$${R}_{x} ( τ ) = \frac{1}{K} \frac{1}{{T}_{o}} {\int }_{- {T}_{o} / 2}^{{T}_{o} / 2} x ( t ) x ( t + τ ) ⅆ t for - ∞ < τ < ∞$$

$$where$$

$$K = \frac{1}{{T}_{o}} {\int }_{- {T}_{o} / 2}^{ {T}_{o} / 2} {x}^{2} ( t ) ⅆ t$$

x(t) is the period waveform representing a linear feedback register sequence (lfrs). For a lfrs code of unit chip (1 clock cycle of shift register) duration with period p chips. Thus:

$${R}_{x} ( τ ) = \frac{1}{p} [ \sum ‘ 1 ’ - \sum ‘ 0 ’ ]$$

where ‘1’ and ‘0’ are binary digits, is a maximum after p chips and in this example the sequence, Y, repeats itself every 15 cycles, as illustrated in FIG. 4. By increasing the number of stages a longer bit pattern can be generated and the code appears more random, i.e. like noise.

If two versions of the code are running, the second having started p chips later than the first, and then summed together, then because of the auto-correlation property two peaks appear, as illustrated in FIG. 6. The distance in chips between the peaks is equal to the time shift. This time shift can be used to encode the time that will elapse before receipt of the next command. To decode this, the receiver has to include a unique code. By using a unique code for each receiver, this means that receivers can be individually addressed. Because the summation of bits is a smoothing process, the accuracy of the synchronisation interval improves by the square of the number of bits in the sequence.

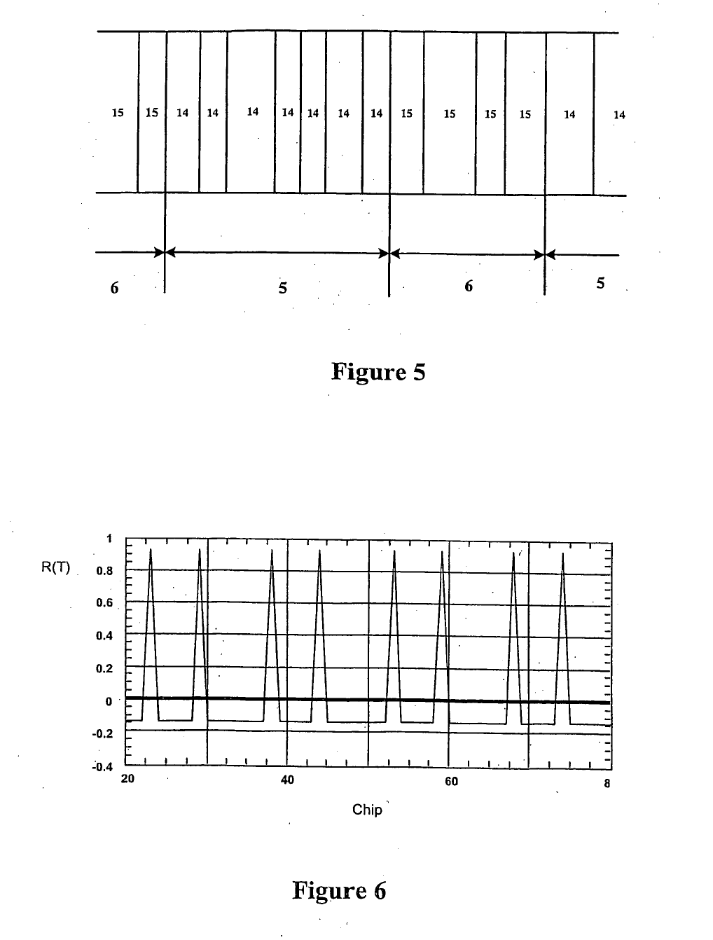

In addition to encoding the synchronisation pulses, the command pulses may be also be encoded as overlapping m-sequence codes 15, as shown in FIG. 5. As before, this allows detection of one signal amongst many or a command to be extracted in a noisy environment. This offers another advantage, because the height of the received peak is equal to the number of correct bits received and therefore provides a statistic to validate the data. For example if the design threshold is 68% (I standard deviation) of the height of the correlation peak then the command data may be accepted or rejected if below this level.

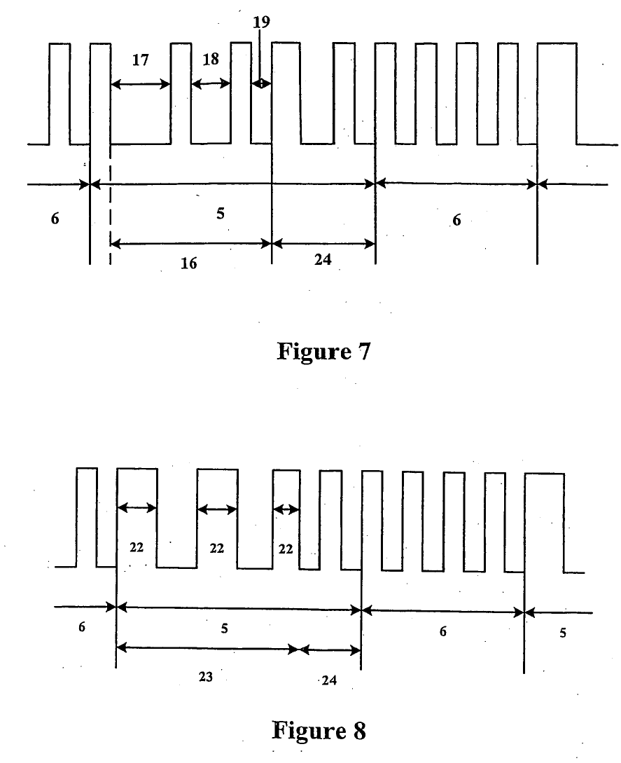

The accuracy of measuring the time interval between the transmission synchronization interval period and the command period may be improved by using a synchronisation pulse length averaging method, as illustrated in FIG. 7. Greater accuracy of measurement of the time interval between the transmission synchronization interval period and the command period is achieved by sampling n intervals in a period of time 16 and taking the time average m, calculated as 16/n, as illustrated in FIG. 7. From this it can be seen that the time interval between edges, numbered 17, 18 and 19, need only change every n intervals, thus giving n intervals of pulses separated by m seconds. The remote receiver samples at some point K 20 in time, where K is the beginning of the sampling interval. Thus the average of n intervals, with A 17, A-1 18, A-2 19 (and so on) widths until the end of n intervals will have a value linearly interpolated in time, and as before be directly proportional to the time of command. Again, this averaged value is arranged to be directly proportional to the time between the beginning of the transmission synchronization interval period and the command period 20 in FIG. 7. Since all that needs to be measured is the time between the edges of the pulses then in this case the width of the pulses 21 is immaterial making this ideally suited to direct sequence ultra-wide band applications.

In order to implement the present invention, each receiver device has to have some mechanisms for identifying the synchronisation message, determining the time until the next command transmission, and then determining when this time has elapsed. For implementing the method described with reference to FIG. 7, a low powered clock and counter could be provided. In this case, the clock periodically turns on the receiver device for a transmission synchronization interval pulse 21 and measures this interval 17, as illustrated in FIG. 7. This interval is scaled in time so that the time between the transmission synchronization interval period and the command period is discovered, and is then loaded into a down counter that counts down the time 20 to turn on the receiver device to coincide with the beginning of the command period 6. The interval period is worked out as follows: t_{c}=tₓ*N, where t_{c} is the time to command 20, and tₛ is the sampled interval 17 and N is constant determined by t_{c}/tₛ.

Alternatively, two count down timers are implemented, the outer one marking the transmission synchronization interval period 5 and the inner one measuring the width of a number of synchronisation pulses 22 within that interval 23 as illustrated in FIG. 8. The averaged measured interval is loaded into a down counter, suitably scaled in time, which counts down the required time to command period 24. The interval before the beginning of the command period is calculated in this case as follows:

$${t}_{c} = \frac{{t}_{s}}{n} * N$$

where t_{c} is the time to command 24 and tₛ is the time 23 between n pulses and N is a pre-determined scaling constant

Optionally, instructions contained within the command data sent by the transmitter device may instruct the receiver device to send a transmission to the transmitter device, enabling said transmitter device to accurately determine the distance to that receiver device. This distance can only be accurately determined when communication between the devices is synchronised accurately. This can be done using a number of different signals, however in a preferred example a m-sequence binary code is used. By sending a m-sequence binary code from the receiver to the transmitter, the timed arrival of the correlation peak allows an estimate of the time of flight of the signal. Knowing the velocity of propagation, the physical distance to the receiver can be calculated.

The receiver devices in which the invention is embodied may be surface mounted or embedded into an object, which may be animate or inanimate. The range of operation may be in excess of three thousand metres in open space, depending on the transmitter power and receiver antenna height. The operational lifetime of these devices have been estimated to exceed seven and half years at an approximate average of five transactions per day using current known battery technology. Where a multitude of the receiver devices exist in close proximity over eighty devices may simultaneously be contacted, either for synchronisation or command, in a relatively short period of time, such as 100 milliseconds.

Potential applications of this invention include, but are not limited to, low power telemetry, remote control devices, radio frequency identification, ultra-wide band wireless and optical links, wildlife tracking, asset tracking, freight management and stock control.

The method for the synchronisation of wireless communication devices in which the invention is embodied has several advantages over the prior art described herein. For example, the receiver device need only be turned on for a minimal time to enable synchronisation with the transmitter device. This time period is much shorter than that utilised in known clock synchronisation methods. This reduces power consumption and consequently prolongs battery life and/or allows smaller batteries to be used within the wireless receiver devices. Furthermore, because the synchronisation pulses provide a time differential that can be used to determine the time of the next command signal, rather than an absolute time, problems associated with synchronised clock time drifting, as described above, are avoided, which again reduces power consumption.

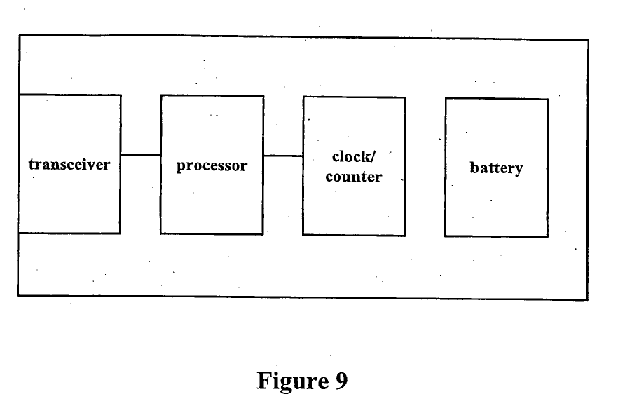

A skilled person will appreciate that variations of the disclosed arrangements are possible without departing from the invention. For example, although some specific configurations for the receiver have been described, any arrangement of the general form shown in FIG. 9 could be used, so long as a means, such as a processor, are provided for determining from a received signal a time that will elapse until a command transmission is due and there is a mechanism for monitoring the elapsed time accordingly.

If the synchronisation period is kept short then low cost resistor-capacitor or ceramic oscillator clocks for the micro-controller can be used, since the timing required is only that for synchronisation period. This allows further reductions in power due to faster start-up times than with traditional crystal based clocks. Also, the receivers may be operable to send signals to the transmitter. In this case, by having three or more receivers the position of the transmitting can be determined using standard triangulation techniques. Because of the improved synchronisation, this can be done more accurately that with more conventional techniques. Also, although the invention is described with reference to any mobile device, it is particularly suited for use with RFID tags and/or mobile devices that are operable in the industrial scientific medical (ISM) frequency band. Accordingly, the above description of a specific embodiment is made by way of example only and not for the purposes of limitations. It will be clear to the skilled person that minor modifications may be made without significant changes to the operation described.

What is claimed is:

1. A method for synchronising a transmitter and a mobile, wireless receiver, the method involving: transmitting from the transmitter a synchronisation message that is indicative of a time until a command transmission; receiving the synchronisation message at the receiver, and using the received synchronisation message to determine when the next command transmission is to occur.

2. A method as claimed in claim 1 wherein the synchronisation message includes a plurality of pulses, each pulse in the sequence being indicative of a time until a command transmission, and the receiver is operable to receive at least one of the pulses, and use it to determine when the next command transmission is to occur.

3. A method as claimed in claim 2 wherein each synchronisation pulse has a width that is usable by the receiver device to work out and identify when a command transmission will be sent to that receiver device.

4. A method as claimed in claim 3, wherein the pulse width is directly proportional to the time until the next command transmission.

5. A method as claimed in claim 1 wherein the synchronisation message includes overlapping m-sequence codes, wherein the separation between auto-correlations peaks of these codes is indicative of the time until the command transmission.

6. A method as claimed in claim 1 wherein the synchronisation message includes a plurality of pulses, and the average width of the pulses is indicative of the time until the command transmission.

7. A method as claimed in claim 1 wherein the synchronisation message includes a plurality of pulses, and the average interval between adjacent pulses is indicative of the time until the command transmission.

8. A system having a transmitter and a mobile, wireless receiver, the transmitter being operable to transmit a synchronisation message that is indicative of a time until a command transmission, and the receiver being operable to receive that synchronisation message, and use it to determine when the next command transmission is to occur.

9. A system as claimed in claim 8 wherein the synchronisation message includes a plurality of pulses, each pulse in the sequence being indicative of a time until a command transmission, and the receiver is operable to receive at least one of the pulses, and use it to determine when the next command transmission is to occur.

10. A system as claimed in claim 9 wherein each synchronisation pulse has a width that is usable by the receiver device to work out and identify when a command transmission will be sent to that receiver device.

11. A system as claimed in claim 10, wherein the pulse width is directly proportional to the time until the next command transmission.

12. A system as claimed in claim 8 wherein the synchronisation message includes overlapping m-sequence codes, wherein the separation between auto-correlations peaks of these codes is indicative of the time until the command transmission.

13. A system as claimed in claim 8 wherein the synchronisation message includes a plurality of pulses, and the average width of the pulses is indicative of the time until the command transmission.

14. A system as claimed in claim 8 wherein the synchronisation message includes a plurality of pulses, and the average interval between adjacent pulses is indicative of the time until the command transmission.

15. A method for synchronising a mobile, wireless receiver with a remote transmitter, the method involving: receiving from the transmitter a synchronisation message that is indicative of a time until a command transmission; and using the received message to determine when the next command transmission is to occur.

16. A mobile device having a receiver, the device being operable to receive from a transmitter a synchronisation message that is indicative of a time until a command transmission, and use the received pulse to determine when the next command transmission is to occur.

17. A method for synchronising a mobile, wireless receiver with a remote transmitter, the method involving transmitting from the transmitter a synchronisation message that is indicative of a time until a command transmission.

18. A transmitter that is operable to communicate with a mobile, wireless receiver the transmitter being operable to transmit a synchronisation message that is indicative of a time until a command transmission.

19. A mobile device that includes a transmitter that is operable to transmit a synchronisation message that is indicative of a time until a command transmission, and a receiver that is operable to receive a synchronisation message that is indicative of a time until a command transmission from another device, and use it to determine when the next command transmission is to occur.
